(19) United States
(12) Patent Application Publication
(10) Pub. No.: US 2024/0136640 A1
(43) Pub. Date: Apr. 25, 2024

(54) CAPACITOR AND ELECTRICAL POWER DEVICE

(71) Applicant: HONDA MOTOR CO., LTD., Tokyo (JP)

(72) Inventors: Daisuke MISU, Saitama (JP); Keiichi ITO, Saitama (JP); Yuya TABUCHI, Saitama (JP); Takashi MATSUMOTO, Saitama (JP); Kosuke YONETA, Saitama (JP)

(21) Appl. No.: 18/547,880

(22) PCT Filed: Feb. 25, 2022
(86) PCT No.: PCT/JP2022/008021

§ 371 Date: Aug. 24, 2023

(30) Foreign Application Priority Data
Feb. 25, 2021 (JP) 2021-029230

(51) Int. Cl. H01M 50/267; H01M 50/249; H01M 50/256; H01M 50/271

(52) U.S. Cl. CPC H01M 50/267; H01M 50/249; H01M 50/256; H01M 50/271; H01M 2220/20

(57) ABSTRACT

A capacitor 1 which is provided so as to be installable in a first loading part C of a first electrical power device and a second loading part S103 of a second electrical power device S is configured to have an external shape such that a first abutment part which, upon loading of the capacitor into the first loading part, comes into abutment with the first loading part C differs from a second abutment part 26 which, upon loading of the capacitor into the second loading part S103, comes into abutment with the second loading part S103.

### TECHNICAL FIELD

The present invention relates to a capacitor and an electric power device.

### BACKGROUND ART

A battery pack as a capacitor that is removably loaded in an electric vehicle or the like has been known (for example, see Patent Documents 1 and 2). The battery pack is used while being disposed in a battery case of the electric vehicle. A charging station for charging battery packs has also been known (see, for example, Patent Document 2). A battery pack is removed from an electric vehicle, and inserted into a receptacle slot of an exchanger installed in the charging station, whereby the battery pack is charged.
Patent Document 1: PCT International Publication No. WO 2020/065868
Patent Document 2: PCT International Publication No. WO 2018/235204

### DISCLOSURE OF THE INVENTION

### Problems to be Solved by the Invention

The battery pack as a capacitor removably loaded in an electric vehicle or the like is required to be reduced in size and weight. On the other hand, when a miniaturized version of a battery pack is inserted into either of an electric vehicle or an exchanger of a charging station, which are adapted to receive the insertion of pre-miniaturized versions of the battery pack, rattling may occur or a fastening surface for fastening the battery pack may have an insufficient width.

An object of the present invention is to provide a capacitor that can avoid a situation in which when the capacitor is inserted into either of an electric vehicle or an exchanger of a charging station, which are adapted to receive the insertion of pre-miniaturized versions of the capacitor, rattling occurs or a fastening surface for fastening the battery pack has an insufficient width, and to provide an electric power device to which the capacitor is loaded.

### Means for Solving the Problems

To achieve the above object, the present invention provides a capacitor (e.g., a battery pack 1 to be described later) that is able to be loaded in a first loading portion (battery case C) of a first electric power device (e.g., an electric vehicle to be described later) and a second loading portion (e.g., an insertion hole S103 to be described later) of a second electric power device (e.g., an exchanger S). The capacitor includes a first contact portion (e.g., sidewalls 4442 and horizontally-thick portions 2442 to be described later) that comes into contact with the first loading portion when the capacitor is loaded in the first loading portion; and a second contact portion (e.g., a side surface 261 of an outer shell case 26 to be described later) that comes into contact with the second loading portion when the capacitor is loaded in the second loading portion, the first contact portion and the second contact portion being different from each other and forming part of an outer shape of the capacitor.

The present invention provides an electric power device including: a first electric power device (e.g., an electric vehicle to be described later) including a first loading portion (a battery case C) in which a capacitor (e.g., a battery pack 1 to be described later) is able to be loaded; and a second electric power device (e.g., an exchanger S to be described later) including a second loading portion (e.g., an exchanger S to be described later) in which the capacitor or a different capacitor that is identical in shape with the capacitor is able to be loaded. The first loading portion has a first contactable portion (e.g., a case's housing part C11 and a case's opening-tubular part C12 to be described later) with which a first contact portion (e.g., sidewalls 4442 and horizontally-thick portions 2442 to be described later) forming part of an outer shape of the capacitor comes into contact when the capacitor is loaded in the first loading portion. The second loading portion has a second contactable portion (e.g., positioning rails S11 and an inner wall S101 to be described later) with which a second contact portion (e.g., a side surface 261 of an outer shell case 26 to be described later) forming part of the outer shape of the capacitor or the different capacitor comes into contact when the capacitor or the different capacitor is loaded in the second loading portion. The second contact portion is different from the first contact portion.

Due to the above features, even in a case where the capacitor is inserted into either of the first electric power device or the second electric power device, which are adapted to receive the insertion of pre-miniaturized versions of the capacitor, the contact portions that are different from each other allow the inserted capacitor to be reliably supported, thereby making it possible to avoid a situation in which rattling occurs or a fastening surface for fastening the capacitor has an insufficient width.

In this case, it is preferable that when viewed in an extending direction in which the capacitor extends, the outer shape has a substantially rectangular shape with four vertexes and four sides connecting the four vertexes to each other, the first contact portion is positioned to correspond to a vicinity of each vertex, and the second contact portion is positioned to correspond to the sides while avoiding the vertexes.

Due to this feature, a configuration is easily achieved in which the contact portion that contacts with the first loading portion when the capacitor is loaded in the first loading portion and the contact portion that contacts with the second loading portion when the capacitor is loaded in the second loading portion are different from each other when viewed in the extending direction of the capacitor.

In this case, it is preferable that the capacitor is composed of at least three members (e.g., a bottom case 24, an outer shell case 26, and a top cover (a handle body 43, a handle cover 44, and a top case 28) to be described later) arranged at different positions in the extending direction of the capacitor, the first contact portion is provided to at least one member (a top cover (a handle body 43, handle cover 44, and a top case 28) to be described later) among the at least three members, the at least one member constituting at least one end portions of the of end portion of capacitor in the extending direction, and the second contact portion is provided to a different one member (e.g., an outer shell case 26 to be described later) among the at least three members, the different one member constituting not the end portions of the capacitor in the extending direction, but an intermediate portion of the capacitor.

Due to this feature, a configuration is easily achieved in which the contact portion that contacts with the first loading portion when the capacitor is loaded in the first loading portion and the contact portion that contacts with the second loading portion when the capacitor is loaded in the second loading portion are different from each other when viewed in the extending direction of the capacitor.

In this case, preferably, the outer shape of the capacitor is such that a maximum outer circumferential length (e.g., a maximum outer circumferential length L2, L3 to be described later) of the outer shape at the at least one member constituting the at least one end portion is greater in directions orthogonal to the extending direction than a maximum outer circumferential length (e.g., a maximum outer circumferential length L1 to be described later) of the outer shape at the different one member constituting the intermediate portion.

Due to this feature, even in the case of a miniaturized version of the capacitor that includes a smaller intermediate portion, rattling can be prevented when the capacitor is loaded in the first loading portion of the first electric power device that is configured to house a pre-miniaturized version of the capacitor, which is large.

In this case, preferably, two members (e.g., sidewalls 4442 and horizontally-thick portions 2442 to be described later) among the at least three members constitute one end portion and an other end portion of the end portions of the capacitor in the extending direction, and the outer shape of the capacitor is such that a maximum outer circumferential length (e.g., a maximum outer circumferential length L2 to be described later) of the outer shape at the one member of the two members that constitutes the one end portion is greater in directions orthogonal to the extending direction than a maximum outer circumferential length (e.g., a maximum outer circumferential length L3 to be described later) of the outer shape at the other member of the two members that constitutes the other end portion. Due to this feature, inserting the member constituting the one end portion into the first loading portion makes it less likely for the capacitor to rattle with respect to the first loading portion.

In this case, preferably, in a state where the capacitor has been loaded in the first loading portion, the one member (e.g., a bottom case 24 to be described later) constituting the one end portion is positioned vertically below the other member (e.g., a top cover (a handle body 43, a handle cover 44, and a top case 28) to be described later) constituting the other end portion. As a result, the member having a large outer shape is positioned lower in the direction of gravity, and the clearance between the capacitor and the first loading portion decreases, whereby the loaded capacitor is brought into a further stable state.

In this case, it is preferable that the at least one member constituting the at least one end portion has a grip (e.g., a handle 42 to be described later) that a user of the capacitor grips, the grip includes a grip skeleton (e.g., a handle body 43 to be described later) and a cover (e.g., a handle cover 44 to be described later) that covers the grip skeleton, and the first contact portion (e.g., sidewalls 4442 to be described later) is provided to the cover. Due to this feature, when dimensional adjustment is needed in order to, for example, load the capacitor in another loading portion, the dimensional adjustment can be performed only by means of the cover without having to modify the grip skeleton.

In this case, it is preferable that the at least one member constituting the at least one end portion is detachably attached to the different one member constituting the intermediate portion. This feature makes it possible to replace only the member that constitutes the end portion and receives a large amount of external force (damage) from the outside, and to continue to use the capacitor for a long period without discarding the entirety.

In this case, it is preferable that the different one member constituting the intermediate portion is superior in strength and/or rigidity to the at least one member constituting the at least one end portion. For example, the different one member constituting the intermediate portion is made of a metal. The at least one member constituting the at least one end portion is made of a resin. This feature makes it possible to continue to use the member constituting the intermediate portion having high strength and/or rigidity for a long period of time.

In this case, the first electric power device is a mobile body that is electrically connectable to the capacitor loaded in the first loading portion and that has a driver configured to be driven by electric power of the capacitor, and the second electric power device is a charge-discharge device that is electrically connectable to the capacitor loaded in the second loading portion and that has at least one of a charger configured to input electric power of external equipment to the capacitor or a discharger configured to output electric power of the capacitor to external equipment. For example, the charge-discharge device is configured as an exchanger having an exchanging function of receiving the capacitor from a user and providing a capacitor in storage in exchange for the capacitor received from the user. The mobile body is a vehicle having a wheel that is driven by the driver. This feature makes it possible to use the capacitor in the charge-discharge device and the mobile body.

### Effects of the Invention

The present invention provides a capacitor that can avoid a situation in which when the capacitor is inserted into either of an electric power device such as an electric vehicle or another electric power device such as an exchanger, which are adapted to receive the insertion of pre-miniaturized versions of the capacitor, rattling occurs or a fastening surface for fastening the battery pack has an insufficient width. The present invention further provides an electric power device to which the capacitor is loaded.

### BRIEF DESCRIPTION OF THE DRAWINGS

FIG. 1 is a perspective view illustrating a battery pack as a capacitor according to an embodiment of the present invention;

FIG. 2 is a bottom perspective view illustrating the battery pack as the capacitor according to the embodiment of the present invention;

FIG. 3 is an exploded perspective view illustrating the battery pack as the capacitor according to the embodiment of the present invention;

FIG. 4 is a side cross-sectional view illustrating a state in which the battery pack as the capacitor according to the embodiment of the present invention is housed in a battery case of an electric vehicle;

FIG. 5 is an enlarged cross-sectional view of an upper front portion, and illustrates the state in which the battery pack as the capacitor according to the embodiment of the present invention is housed in the battery case of the electric vehicle;

FIG. 6 is an enlarged cross-sectional view of an upper rear portion, and illustrates the state in which the battery pack as the capacitor according to the embodiment of the present invention is housed in the battery case of the electric vehicle;

FIG. 7 is a rear cross-sectional view illustrating the state in which the battery pack as the capacitor according to the embodiment of the present invention is housed in the battery case of the electric vehicle;

FIG. 8 is an enlarged cross-sectional view of a lower front portion, and illustrates the state in which the battery pack as the capacitor according to the embodiment of the present invention is housed in the battery case of the electric vehicle;

FIG. 9 is an enlarged cross-sectional view of a lower rear portion, and illustrates the state in which the battery pack as the capacitor according to the embodiment of the present invention is housed in the battery case of the electric vehicle; and

FIG. 10 is a bottom cross-sectional view illustrating a state in which the battery pack as the capacitor according to the embodiment of the present invention is disposed in an insertion hole of an exchanger.

### PREFERRED MODE FOR CARRYING OUT THE INVENTION

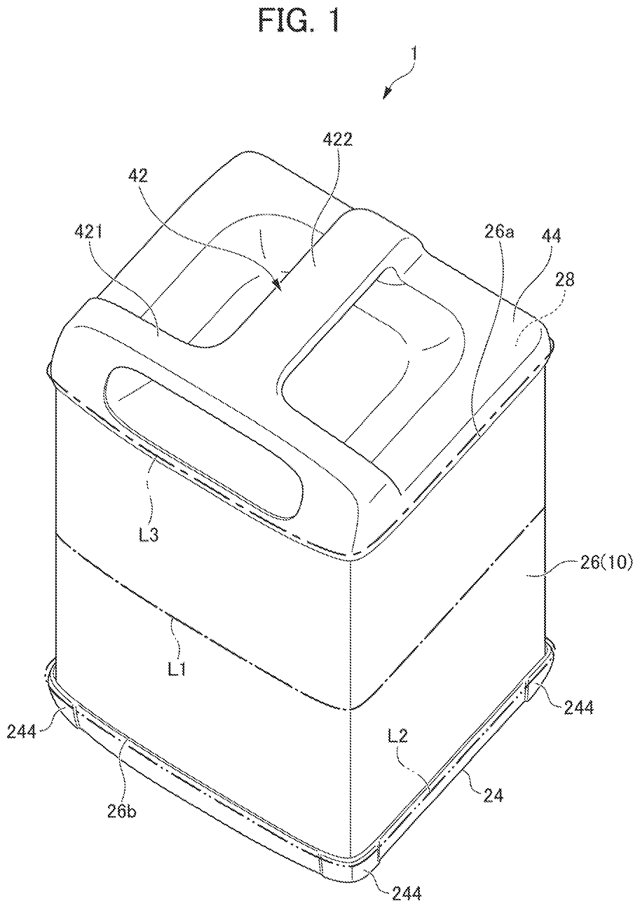

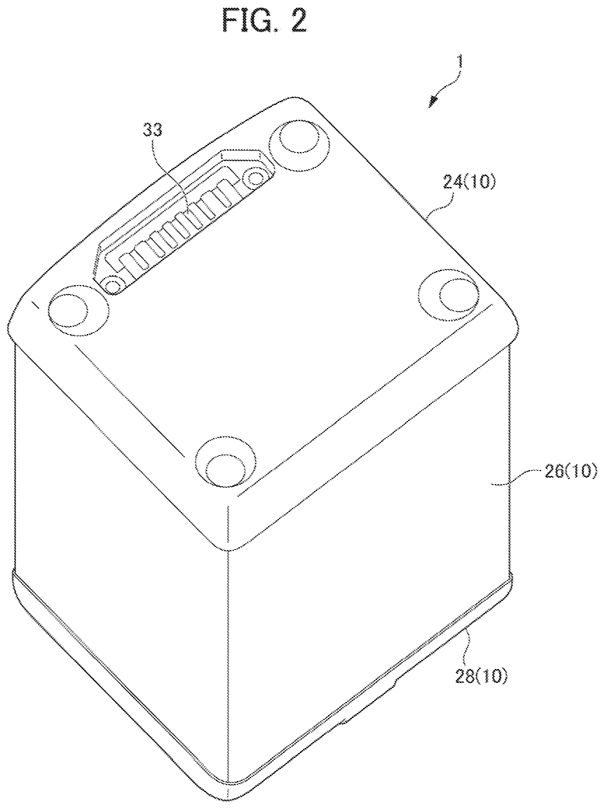

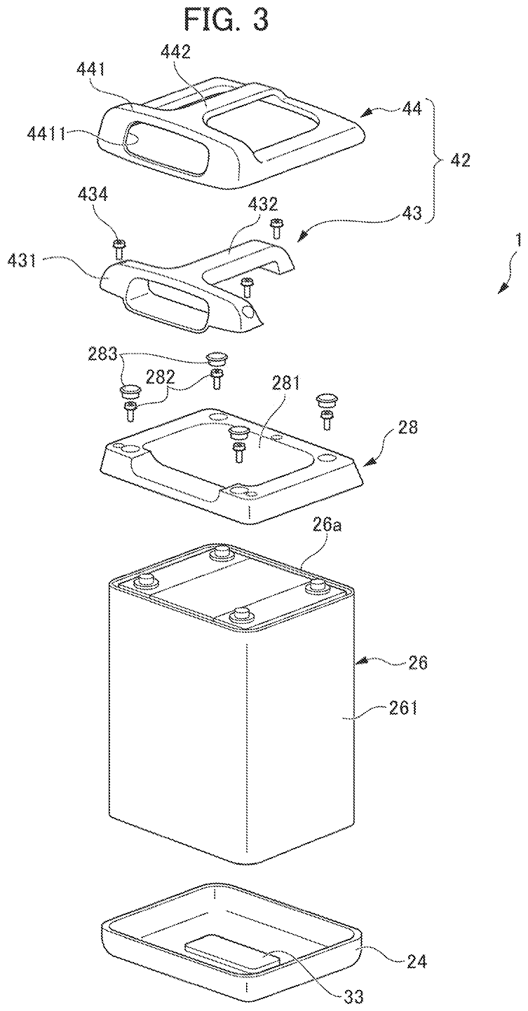

Embodiments of the present invention will be described in detail, with reference to the drawings. FIG. 1 is a perspective view illustrating a battery pack 1. FIG. 2 is a bottom perspective view illustrating the battery pack 1. FIG. 3 is an exploded perspective view illustrating the battery pack 1. In the following description, an upper side (side provided with a handle 42) shown in FIG. 1 is defined as the upper side, and an opposite side (the lower side in FIG. 1) is defined as the lower side.

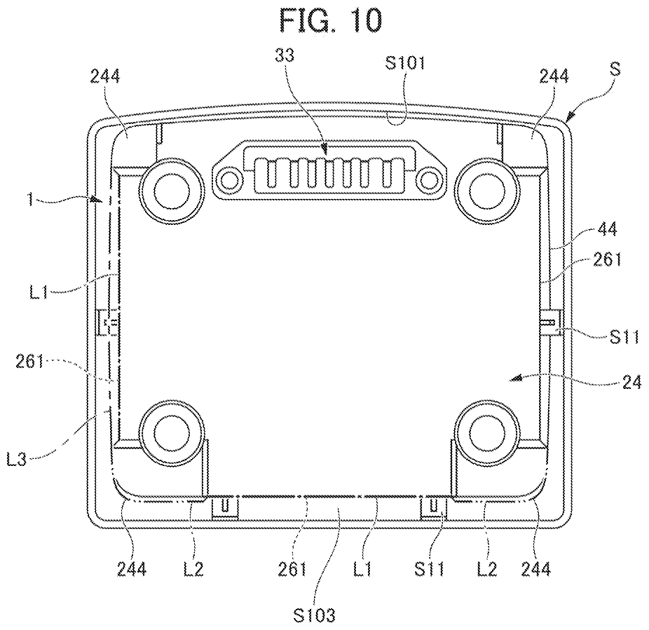

The portable battery pack 1 as a capacitor is suitably applied to, for example, a portable drive power source (mobile power pack; MPP) that is removably loaded to an electric power-assisted bicycle, an electric motorcycle, and the like. The battery pack 1 as a capacitor includes a storage battery case 10 that forms a substantially rectangular parallelepiped exterior jacket, and a battery group as a power storage unit housed in the storage battery case 10. The battery pack 1 has a rectangular parallelepiped outer shape. As illustrated in FIG. 10, when viewed in an extending direction in which the battery pack 1 extends, it has a substantially rectangular shape with four vertexes and four sides connecting the four vertexes to each other. The extending direction in which the battery pack 1 as the capacitor extends is also a loading direction in which the battery pack 1 is loaded in electric power devices, example of which include an electric vehicle (e.g., an electric power-assisted bicycle, an electric motorcycle, etc.) and an exchanger S.

The storage battery case 10 constitutes a casing and houses a battery core pack (not shown) constituting the battery group. The storage battery case 10 may be formed of, for example, a metal such as aluminum, a resin (including a fiber reinforced resin), and the like. The storage battery case 10 includes a bottom case 24, an outer shell case 26, and a top cover that includes a handle body 43, a handle cover 44, and a top case 28.

The bottom case 24 is formed separately from the battery group (not shown), is disposed outside and below the battery group, opens at its upper end, and has a rectangular shape in plan view. A connector 33 and the like are accommodated in the bottom case 24.

The connector 33 is exposed to the outside of the case 12 through, for example, a through hole (not shown) formed in the bottom wall of the bottom case 24, and is electrically connectable to a power supply port of an electric vehicle or a charging device for charging the battery group (not shown). By connecting the connector 33 to the power supply port or the charging device, the power supply port or the charging device and the battery group (not shown) are electrically connected to each other via a BMU (not shown).

The outer shell case 26 (see FIG. 1) has a quadrangular tubular shape and covers a side surface of the battery group (not shown). The outer shell case 26 has an upper end that opens upward at an upper opening 26a, and a lower end that opens downward at a lower opening 26b. In a state where the lower opening 26b is covered by the bottom case 24 and the upper opening 26a is covered by the top case 28, the battery group (not shown), the BMU (not shown), etc. are accommodated in an interior space of the outer shell case 26. Seal rings (not shown) are each provided on the entire circumference of the boundary between the top case 28 and the outer shell case 26, and the entire circumference of the boundary between the bottom case 24 and the outer shell case 26.

The top case 28 is a casing that is formed separately from the battery group (not shown), is disposed outside and above the battery group, and opens at its lower end, and has a rectangular shape in plan view.

The top case 28 has, in a central portion of its upper surface, a recess 281 that is depressed downward so as to make it unlikely for a user's hand gripping the handle 42 to come into contact with the upper surface of the top case 28. The four corners of the top case 28 are fixed to the outer shell case 26 with bolts 282, and waterproof caps 283 for preventing ingress of water from the locations where the bolts 282 are provided are attached to cover the bolts 282.

As illustrated in FIG. 1, the handle 42 is coupled to an upper surface 28a of the top case 28. The handle 42 is gripped by the user, for example, when the user carries the battery pack 1.

The handle 42 includes a first handle part 421 and a second handle part 422. The first handle part 421 is disposed along the outer periphery of the upper surface 28a of the top case 28. The second handle part 422 is disposed so as to extend in a direction orthogonal to the first handle part 421.

Specifically, the handle 42 includes the handle body 43 and the handle cover 44 that covers the entire handle body 43. In plan view, the handle body 43 has a T-shape including a first body part 431 constituting the first handle part 421, and a second body part 432 constituting the second handle part 422. The three ends of the T-shape are fastened to the top case 28 with bolts 434. The handle cover 44 includes a first cover part 441 constituting the first handle part 421, and a second cover part 442 constituting the second handle part 422.

A central portion of the first body part 431 has a substantially O-shaped opening that opens in the front-rear direction. The first cover part 441 of the handle cover 44 has an opening 4411 having the same shape as the substantially O-shaped opening in the central portion of the first body part 431.

The battery core pack (not shown) constituting the battery group (not shown) includes a plurality of battery cells and a plurality of cell holders that hold the battery cells. The battery cells are preferably, but are not limited to, lithium-ion secondary batteries. For example, secondary batteries such as all-solid batteries, nickel hydrogen batteries, and nickel cadmium batteries may be used as the battery cells. A plurality of bus bar plates (not shown) are provided so as to cover the positive electrode terminals and the negative electrode terminals of the plurality of battery cells, respectively, such that each bus bar plate connects in parallel a predetermined number of the positive electrode terminals to each other or a predetermined number of the negative electrode terminals to each other. The plurality of bus bar plates are connected to each other in series, and are connected to the connector 33 via the BMU (not shown).

Next, details of an insertion hole S103 of the exchanger S installed in a charging station for charging the battery pack 1, a battery case C of an electric vehicle, and the handle cover 44 and the bottom case 24 of the battery pack 1 will be described. The exchanger S allows for exchange of battery packs 1 by receiving a battery pack 1 used by a user and providing a new battery pack 1 that is stored. The battery pack 1 received from the user is charged and stored in the exchanger S. That is, the exchanger S also functions as a charger having a function of charging the battery pack 1. Furthermore, the exchanger S may function as a discharger having a function of supplying the electric power of the battery pack 1 in storage to equipment outside of the exchanger S.

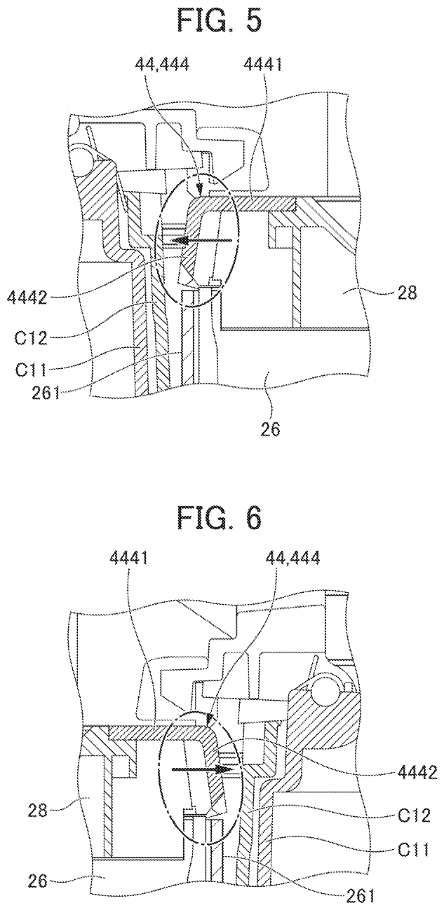

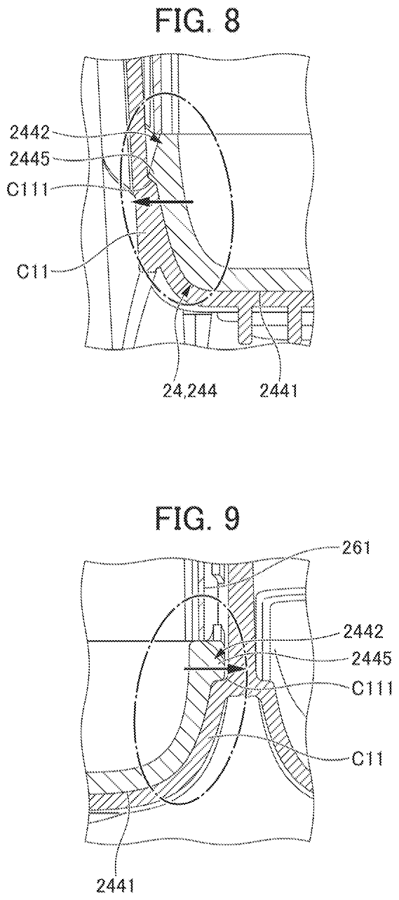

In FIGS. 1 and 10, a thin one-dot chain line indicates a maximum outer circumferential length L3 of the outer shape of the handle cover 44 (see FIG. 3) in directions orthogonal to the vertical direction in FIG. 1, which is the extending direction in which the battery pack 1 extends. The maximum outer circumferential length L3 is defined by portions, of sidewalls 4442 (see FIGS. 5 and 6), that protrude most in the foregoing directions. Since the handle cover 44 protrudes more in the foregoing directions than a side surface 261, the maximum outer circumferential length L3 is longer than a maximum outer circumferential length L1 of the outer shape of the outer shell case 26 in the foregoing directions, which is indicated by a thick one-dot chain line. In FIGS. 1 and 10, a thick two-dot chain line indicates a maximum outer circumferential length L2 of the outer shape of the bottom case 24 in directions orthogonal to the vertical direction in FIG. 1, which is the extending direction of battery pack 1. The maximum outer circumferential length L2 is defined by portions, of horizontally-thick portions 2442 (see FIGS. 8 and 9), that protrude most in the foregoing directions. The maximum outer circumferential length L2 is longer than the maximum outer circumferential length L1 of the outer shape of the outer shell case 26 in the foregoing directions and longer than the maximum outer circumferential length L3. That is, the maximum outer circumferential length L2 is the longest among the maximum outer circumferential lengths L1 to L3.

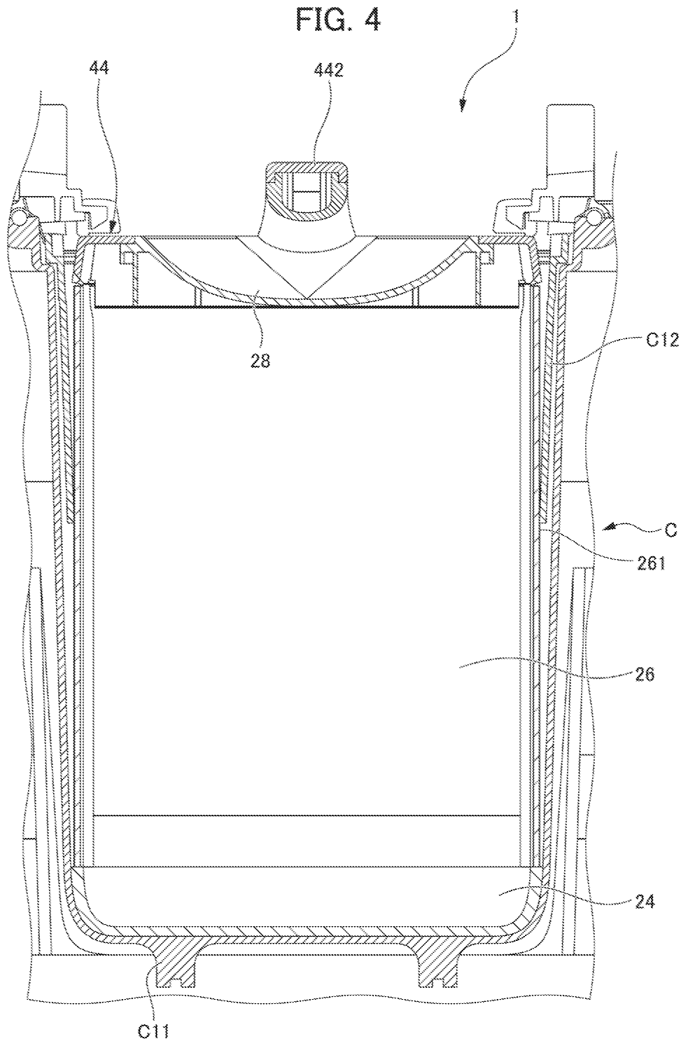

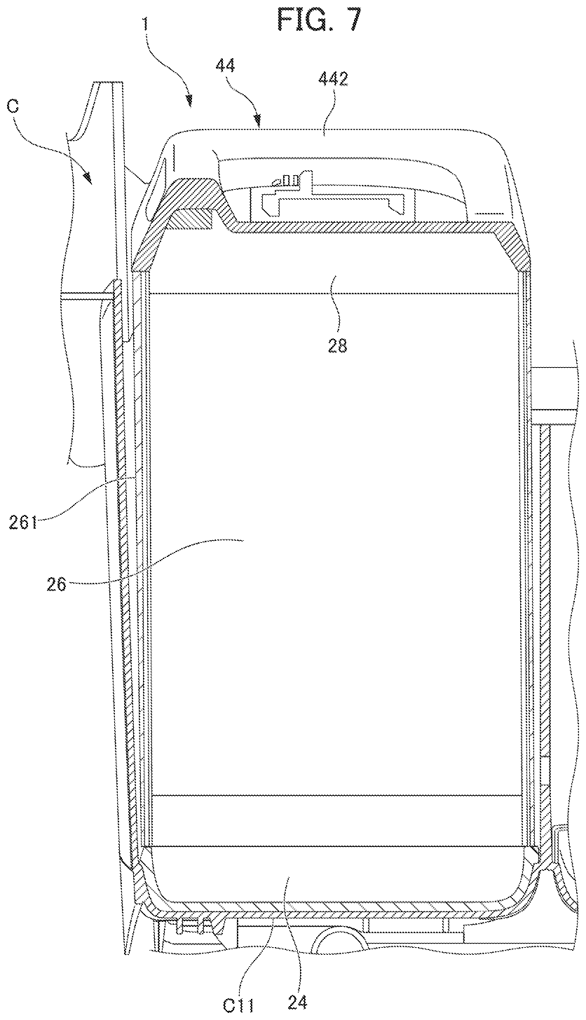

FIG. 4 is a side cross-sectional view illustrating a state in which the battery pack 1 is housed in the battery case C of the electric vehicle. FIG. 5 is an enlarged cross-sectional view of an upper front portion, and illustrates the state in which the battery pack 1 is housed in the battery case C of the electric vehicle. FIG. 6 is an enlarged cross-sectional view of an upper rear portion, and illustrates the state in which the battery pack 1 is housed in the battery case C of the electric vehicle. FIG. 7 is a rear cross-sectional view illustrating the state in which the battery pack 1 is housed in the battery case C of the electric vehicle. FIG. 8 is an enlarged cross-sectional view of a lower front portion, and illustrates the state in which the battery pack 1 is housed in the battery case C of the electric vehicle. FIG. 9 is an enlarged cross-sectional view of a lower rear portion, and illustrates the state in which the battery pack 1 is housed in the battery case C of the electric vehicle. FIG. 10 is a bottom cross-sectional view illustrating a state in which the battery pack 1 is disposed in the insertion hole S103 of the exchanger S. In FIG. 10, for the sake of convenience, the maximum outer circumferential lengths L1 and L3 are indicated only on the left side, and are omitted from the right side.

As shown in FIG. 10, the exchanger S has an inner wall S101 defining the insertion hole S103 into which the battery pack 1 can be inserted, and the battery pack 1 is inserted into the insertion hole 3103 with the bottom case 24 first. The insertion hole S103 is formed in a tubular shape closed with a bottom, and has a quadrangular shape as viewed in a cross section orthogonal to the longitudinal direction of the battery pack 1. With respect to the page of FIG. 10, the bottom (not shown) is located closer to the viewer. The bottom (not shown) of the inner wall S101 is provided with a terminal (not shown) that is electrically connectable to the connector 33.

The inner wall S101 having quadrangular shape in a cross-sectional view has one side (the upper side of the inner wall 3101 of the insertion hole S103 in FIG. 10) that is curved and convex toward the outside of the exchanger S, and the other three sides (the left, right, and lower sides of the inner wall S101 in FIG. 10) are straight. As illustrated in FIG. 10, in a cross-sectional view orthogonal to the longitudinal direction of the battery pack 1, the substantially quadrangular shape defined by the inner peripheral surface of the inner wall S101 is larger than the substantially quadrangular shape defined by the maximum outer circumferential length of the outer shape of the outer shell case 26 (the maximum outer circumferential length L2 in FIG. 1) of the battery pack 1 in the same cross-sectional view, and therefore, a space is formed between the battery pack 1 and the inner wall S101 of the insertion hole S103.

In this space, positioning rails S11 are provided on the three straight sides of the inner wall S101, which has the quadrangular shape in a cross-sectional view orthogonal to the longitudinal direction of the battery pack 1. The positioning rails S11 extend in a direction in which the battery pack 1 is inserted into the insertion hole S103 defined by the inner wall S101 (a direction parallel to the longitudinal direction of the battery pack 1 to be inserted). The one curved side is not provided with the positioning rail S11, whereas each of the two sides (left and right sides of the inner wall S101 in FIG. 10) adjacent to the one curved side has, in its central portion, one positioning rail S11 fixed to the inner wall 3101.

The remaining side (lower side of the inner wall S101 in FIG. 10) is provided with two positioning rails S11 that are fixed to the inner wall S101. The two positioning rails S11 are spaced apart from each other between adjacent outward thick portions 244 (to be described later) of the bottom case 24 of the battery pack 1 in a bottom view of the battery pack 1 shown in FIG. 10. The positioning rails S11 come into contact with the outer shell case 26 of the battery pack 1 so as to support the battery pack 1.

The battery case C of the electric vehicle is capable of accommodating not only the battery pack 1, but also a battery pack (not shown) having an outer shell case slightly larger than the outer shell case 26 of the battery pack 1, instead of the battery pack 1. As illustrated in, for example, FIGS. 5 and 6, the battery case C of the electric vehicle includes a case's housing part C11 and a case's opening-tubular part C12.

The case's housing part C11 has a bottomed tubular shape that defines an insertion hole into which the battery pack 1 can be inserted. The case's opening-tubular part C12 is fixed to the upper end opening of the case's housing part C11 and an inner peripheral surface in the vicinity the upper end opening, and has a tubular shape opening at both ends. The bottom of the case's housing part C11 is provided with a terminal (not shown) that comes into contact with, and is electrically connected to, the connector 33. Furthermore, as illustrated in FIGS. 8 and 9, in a lower portion of a side of the case's housing part C11 that is close to the bottom of the case's housing part C11, a step portion C111 is provided at which the width of the case's housing part C31 increases upward by one step.

As illustrated in FIGS. 5 and 6, the handle cover 44 has a peripheral edge portion 444 that includes an upper wall 4441 and the sidewalls 4442. The sidewalls 4442 are thicker than the upper wall 4441. For this reason, when viewed in a cross section taken along a horizontal plane parallel to a direction orthogonal to the vertical direction in FIG. 4, which is the extending direction of the battery pack 1 (the longitudinal direction), the sidewalls 4442 protrude relative to the side surface 261 of the outer shell case 26 toward the outside of the battery pack 1 (toward the left in FIG. 5 and the right in FIG. 6).

As illustrated in FIGS. 8 to 10, the four corner portions of the bottom case 24, which has a rectangular shape in plan view, each have the outward thick portion 244 that includes a vertically-thick portion 2441 and the horizontally-thick portion 2442. The vertically-thick portion 2441 is thick in the longitudinal direction, which is the extending direction of the battery pack 1, whereas the horizontally-thick portion 2442 is thick in the horizontal direction, which is the direction orthogonal to the longitudinal direction.

As illustrated in FIG. 10, each outward thick portion 244 is provided over a corresponding corner and the vicinity of the corner, i.e., portions of the two sides between which the corner is located. As illustrated in FIGS. 8 and 9, an upper portion of each horizontally-thick portion 2442 is provided with a step-engaging portion 2445 that is engageable with the step portion C111 of the battery case C of the electric vehicle. Since the step-engaging portion 2445 is provided, the thickness of each horizontally-thick portion 2442 upwardly increases by one step at the step-engaging portion 2445.

Engagement of the step-engaging portion 2445 with the step portion C111 of the battery case C makes it possible for the battery pack 1 to be housed in the battery case C without rattling. Furthermore, when inserted into the exchanger S, the positioning rails S11 come into contact with the side surface 261 of the outer shell case 26, and the inner surface of one side of the inner wall S101 (the upper side of the inner wall S101 in FIG. 10), which is curved and upwardly convex toward the outside of the exchanger S, comes into contact with one side of the side surface 261 of the outer shell case 26 (the upper side of the outer shell case 26 in FIG. 10), which is curved and convex toward the outside of the battery pack 1, thereby allowing the battery pack 1 to be housed in the exchanger S without rattling.

The present embodiment exerts the following effects. According to the present embodiment, the battery pack 1 is able to be loaded in the battery case C of the electric vehicle and the insertion hole S103 of the exchanger S of the charging station. The battery pack 1 includes the sidewalls 4442 and the horizontally-thick portions 2442 that function as a contact portion that comes into contact with the battery case C when the battery pack 1 is loaded in the battery case C, and the outer shell case 26 that functions as a contact portion that comes into contact with the exchanger S when the battery pack 1 is loaded in the exchanger S. The contact portions are different from each other and form part of the outer shape of the battery pack 1.

Due to this feature, even in a case where the battery pack 1 is inserted into either of the electric vehicle or the insertion hole S103 of the exchanger S of a charging station, which are adapted to receive the insertion of pre-miniaturized versions of the battery pack, the contact portions that are different from each other allow the inserted battery pack 1 to be reliably supported, thereby making it possible to avoid a situation in which rattling occurs and a fastening surface for fastening the battery pack 1 has an insufficient width.

In the present embodiment, when viewed in the extending direction in which the battery pack 1 extends, the outer shape of the battery pack 1 has a substantially rectangular shape with four vertexes and four sides connecting the four vertexes to each other. The sidewalls 4442 and the horizontally-thick portions 2442 are positioned to correspond to the vicinities of the vertexes, and the outer shell case 26 is positioned to correspond to the sides while avoiding the vicinities of the vertexes.

Due to this feature, a configuration is easily achieved in which the contact portion that contacts with the battery case C when the battery pack 1 is loaded in the battery case C and the contact portion that contacts with the exchanger S when the battery pack 1 is loaded in the exchanger S are different from each other when viewed in the extending direction of the battery pack 1.

In the present embodiment, the battery pack 1 is composed of at least three members (the bottom case 24, the outer shell case 26, the top cover (the handle body 43, the handle cover 44, and the top case 28)) arranged in the extending direction of the battery pack 1. The sidewalls 4442 and the horizontally-thick portions 2442 are provided to the top cover (the handle body 43, the handle cover 44, and the top case 28), among the at least three members, which constitutes one end portion of end portions of the battery pack 1 in the extending direction, and the outer shell case 26 is composed of a different one member, among the at least three members, which constitutes not the end portions of the battery pack 1 in the extending direction, but an intermediate portion of the battery pack 1.

Due to this feature, a configuration is easily achieved in which the contact portion that contacts with the battery case C when the battery pack 1 is loaded in the battery case C and the contact portion that contacts with the exchanger S when battery pack 1 is loaded in the exchanger S are different from each other when viewed in the extending direction of the battery pack 1.

In the present embodiment, the outer shape of the battery pack 1 is such that the maximum outer circumferential lengths L2 and L3 of the outer shapes of the sidewalls 4442 and the horizontally-thick portions 2442 of the members that constitute the end portions are greater in directions orthogonal to the extending direction of the battery pack 1 than the maximum outer circumferential length L1 of the outer shape of the outer shell case 26 as the member constituting the intermediate portion.

Due to this feature, even in the case of a miniaturized version of the battery pack 1 that includes a smaller outer shell case 26 as the intermediate portion, rattling can be prevented when the battery pack 1 is loaded in the battery case C of the electric vehicle that is configured to house a pre-miniaturized version of the battery pack 1, which is large.

In the present embodiment, the sidewalls 4442 and the horizontally-thick portions 2442 respectively constitute one end portion and the other end portion of the battery pack 1 in the extending direction, and the outer shape of the battery pack 1 is such that the maximum outer circumferential length L2 of the outer shape of the horizontally-thick portions 2442 constituting one of the two end portions is greater in directions orthogonal to the extending direction than the maximum outer circumferential length L3 of the outer shape of the sidewalls 4442 constituting the other end portion.

Due to this feature, inserting the bottom case 24, which has the horizontally-thick portions 2442 and constitutes the one end portion, into the battery case C makes it less likely for the battery pack 1 to rattle with respect to the battery case C.

In the present embodiment, in a state where the battery pack 1 has been loaded in the battery case C, the bottom case 24 is positioned vertically below the top cover (the handle body 43, the handle cover 44, and the top case 28). As a result, the bottom case 24, which is a member having a large outer shape, is positioned lower in the direction of gravity, and the clearance between the bottom case 24 and the case's housing part C11 decreases, whereby the loaded battery pack 1 is brought into a further stable state.

In the present embodiment, the top cover (the handle body 43, the handle cover 44, and the top case 28) has the handle 42 that the user of the battery pack 1 grips, the handle 42 includes the handle body 43 and the handle cover 44 covering the handle body 43, and the sidewalls 4442 are provided to the handle cover 44. Due to this feature, when dimensional adjustment is needed in order to, for example, load the battery pack in another loading portion, the dimensional adjustment can be performed only by means of the handle cover without having to modify the handle body.

It should be noted that the present invention is not limited to the embodiment described above, and modifications, improvements, and the like are encompassed in the present invention as long as the object of the present invention can be achieved. For example, the configurations of the capacitor, the first loading portion of the first electric power device, the second loading portion of the second electric power device, etc. are not limited to the configurations of the battery pack 1, the battery case C, the insertion hole S103 of the exchanger S, etc. of the embodiment described above. For example, while the battery pack 1 includes the three members, namely, the bottom case 24, the outer shell case 26, and the top cover (the handle body 43, the handle cover 44, and the top case 28), the battery pack 1 only needs to include at least three members.

Furthermore, the battery pack 1 as a capacitor is applied to, for example, a mobile drive power source detachably loaded in an electric power-assisted bicycle, an electric motorcycle, or the like, but the application is not limited thereto. For example, the battery pack 1 may be applied as a capacitor incorporated in an electric appliance.

Moreover, for example, the outer shell case 26 may be made of a metal, such as aluminum, which is superior in strength and rigidity to a resin, and the bottom case 24, the top case 28, the handle body 43, and the handle cover 44 may each be made of a resin (including a fiber reinforced resin).

### EXPLANATION OF REFERENCE NUMERALS

1: Battery pack (Capacitor)
24: Bottom case (member constituting one end portion)
26: Outer shell case (Intermediate portion)
28: Top case (member constituting the other end portion)
43: Handle body (member constituting the other end portion; grip skeleton)
44: Handle cover (member constituting the other end portion; cover)
261: Side surface (second contact portion)
2442: Horizontally-thick portion (first contact portion)
4442: Sidewall (first contact portion)
C: Battery case (first loading portion)
C11: Case's housing part (first contactable portion)
C12: Case's opening-tubular part (first contactable portion)
L1: Maximum outer circumferential length
L2: Maximum outer circumferential length
L3: Maximum outer circumferential length
S: Exchanger (second electric power device)
S103: Insertion hole (second loading portion)
S11: Rail (second contactable portion)
S101: Inner wall (second contactable portion)

1. A capacitor that is able to be loaded in a first loading portion of a first electric power device and a second loading portion of a second electric power device, the capacitor comprising:
a first contact portion that comes into contact with the first loading portion when the capacitor is loaded in the first loading portion; and
a second contact portion that comes into contact with the second loading portion when the capacitor is loaded in the second loading portion,
the first contact portion and the second contact portion being different from each other and forming part of an outer shape of the capacitor.

2. The capacitor according to claim 1, wherein
when viewed in an extending direction in which the capacitor extends, the outer shape has a substantially rectangular shape with four vertexes and four sides connecting the four vertexes to each other,
the first contact portion is positioned to correspond to a vicinity of each vertex, and
the second contact portion is positioned to correspond to the sides while avoiding the vertexes.

3. The capacitor according to claim 1, wherein
the capacitor is composed of at least three members arranged at different positions in the extending direction of the capacitor,
the first contact portion is provided to at least one member among the at least three members, the at least one member constituting at least one end portion of end portions of the capacitor in the extending direction, and
the second contact portion is provided to a different one member among the at least three members, the different one member constituting not the end portions of the capacitor in the extending direction, but an intermediate portion of the capacitor.

4. The capacitor according to claim 3, wherein
the outer shape of the capacitor is such that a maximum outer circumferential length of the outer shape at the at least one member constituting the at least one end portion is greater in directions orthogonal to the extending direction than a maximum outer circumferential length of the outer shape at the different one member constituting the intermediate portion.

5. The capacitor according to claim 3, wherein
two members among the at least three members constitute one end portion and an other end portion of the end portions of the capacitor in the extending direction, and
the outer shape of the capacitor is such that a maximum outer circumferential length of the outer shape at the one member of the two members that constitutes the one end portion is greater in directions orthogonal to the extending direction than a maximum outer circumferential length of the outer shape at the other member of the two members that constitutes the other end portion.

6. The capacitor according to claim 5, wherein
in a state where the capacitor has been loaded in the first loading portion, the one member constituting the one end portion is positioned vertically below the other member constituting the other end portion.

7. The capacitor according to claim 3, wherein
the at least one member constituting the at least one end portion has a grip that a user of the capacitor grips,
the grip includes a grip skeleton and a cover that covers the grip skeleton, and
the first contact portion is provided to the cover.

8. The capacitor according to claim 3, wherein
the at least one member constituting the at least one end portion is detachably attached to the different one member constituting the intermediate portion.

9. The capacitor according to claim 3, wherein
the different one member constituting the intermediate portion is superior in strength and/or rigidity to the at least one member constituting the at least one end portion.

10. The capacitor according to claim 9, wherein
the different one member constituting the intermediate portion is made of a metal.

11. The capacitor according to claim 9, wherein
the at least one member constituting the at last one end portion is made of a resin.

12. The capacitor according to claim 1, wherein
the first electric power device is a mobile body that is electrically connectable to the capacitor loaded in the first loading portion and that has a driver configured to be driven by electric power of the capacitor, and
the second electric power device is a charge-discharge device that is electrically connectable to the capacitor loaded in the second loading portion and that has at least one of a charger configured to input electric power of external equipment to the capacitor or a discharger configured to output electric power of the capacitor to external equipment.

13. The capacitor according to claim 12, wherein
the charge-discharge device is configured as an exchanger having an exchanging function of receiving the capacitor from a user and providing a capacitor in storage in exchange for the capacitor received from the user.

14. The capacitor according to claim 12, wherein
the mobile body is a vehicle having a wheel that is driven by the driver.

15. An electric power device comprising:
a first electric power device including a first loading portion in which a capacitor is able to be loaded; and
a second electric power device including a second loading portion in which the capacitor or a different capacitor that is identical in shape with the capacitor is able to be loaded,
the first loading portion having a first contactable portion with which a first contact portion forming part of an outer shape of the capacitor comes into contact when the capacitor is loaded in the first loading portion, and
the second loading portion having a second contactable portion with which a second contact portion forming part of the outer shape of the capacitor or the different capacitor comes into contact when the capacitor or the different capacitor is loaded in the second loading portion,
the second contact portion being different from the first contact portion.
